(19) United States
(12) Patent Application Publication
(10) Pub. No.: US 2023/0401491 A1
(43) Pub. Date: Dec. 14, 2023

(54) Generation and Explanation of Transformer Computation Graph Using Graph Attention Model

(71) Applicant: Microsoft Technology Licensing, LLC, Redmond, WA (US)

(72) Inventors: Leo Moreno BETTHAUSER, Kirkland, WA (US); Maurice DIESENDRUCK, Bellevue, WA (US)

(73) Assignee: Microsoft Technology Licensing, LLC, Redmond, WA (US)

(21) Appl. No.: 17/840,169

(22) Filed: Jun. 14, 2022

(51) Int. Cl. G06N 20/20; G06K 9/62

(52) U.S. Cl. CPC G06N 20/20; G06K 9/6215; G06K 9/6262; G06K 9/6296

(57) ABSTRACT

A data processing system implements obtaining attention matrices from a first machine learning model that is pretrained and includes a plurality of self-attention layers. The data processing system further implements analyzing the attention matrices to generate a computation graph based on the attention matrices. The computation graph provides a representation of behavior of the first machine learning model across the plurality of self-attention layers. The data processing system is further implements analyzing the computation graph using a second machine learning model. The second machine learning model is trained to receive the computation graph to output model behavior information. The model behavior information identifying which layers of model performed specific tasks associated with generating predictions by the first machine learning model.

### BACKGROUND

Machine learning models have been developed to analyze various types of inputs and to make various types of predictions based on these inputs. Determining whether a model is performing as desired can be particularly challenging. Models are not explicitly programmed to make specific predictions. Instead, the models are trained to make inferences based on the input data and determining how the model has generated a particular prediction is often difficult or impossible to determine based on the output of the model alone. Hence, there is a need for improved systems and methods that provide a technical solution for assessing the performance of machine learning models.

### SUMMARY

An example data processing system according to the disclosure may include a processor and a machine-readable medium storing executable instructions. The instructions when executed cause the processor to perform operations including obtaining attention matrices from a first machine learning model, the first machine learning model having been pretrained, the first machine learning model including a plurality of self-attention layers, and the attention matrices being associated with the plurality of self-attention layers of the first machine learning model; analyzing the attention matrices to generate a computation graph based on the attention matrices, the computation graph providing a representation of behavior of the first machine learning model across the plurality of self-attention layers; and analyzing the computation graph using a second machine learning model, the second machine learning model being trained to receive the computation graph to output model behavior information, the model behavior information identifying which layers of model performed specific tasks associated with generating predictions by the first machine learning model.

An example method implemented in a data processing system for analyzing performance of a machine learning model includes obtaining attention matrices from a first machine learning model, the first machine learning model having been pretrained, the first machine learning model including a plurality of self-attention layers, and the attention matrices being associated with the plurality of self-attention layers of the first machine learning model; analyzing the attention matrices to generate a computation graph based on the attention matrices, the computation graph providing a representation of behavior of the first machine learning model across the plurality of self-attention layers; and analyzing the computation graph using a second machine learning model, the second machine learning model being trained to receive the computation graph to output model behavior information, the model behavior information identifying which layers of model performed specific tasks associated with generating predictions by the first machine learning model.

An example machine-readable medium on which are stored instructions according to the disclosure includes instructions, which when executed, cause a processor of a programmable device to perform operations of obtaining attention matrices from a first machine learning model, the first machine learning model having been pretrained, the first machine learning model including a plurality of self-attention layers, and the attention matrices being associated with the plurality of self-attention layers of the first machine learning model; analyzing the attention matrices to generate a computation graph based on the attention matrices, the computation graph providing a representation of behavior of the first machine learning model across the plurality of self-attention layers; and analyzing the computation graph using a second machine learning model, the second machine learning model being trained to receive the computation graph to output model behavior information, the model behavior information identifying which layers of model performed specific tasks associated with generating predictions by the first machine learning model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein may be implemented.

FIGS. 2A, 2B, and 2C show example implementations of a transformer model that may be used to implement the pre-trained model shown in FIG. 1.

FIGS. 3A and 3B are diagrams that show examples self-attention values developed by the self-attention layers of the transformer model shown in FIG. 2.

FIGS. 4A, 4B, and 4C are diagrams of an example computation graph generated by the computation graph unit from the self-attention values shown in FIGS. 3A and 3B.

FIG. 5 is a flow diagram of a process for analyzing performance of a machine learning model according to the techniques provided herein.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques for analyzing the performance of a machine learning model are provided that solve the technical problem of understanding how the machine learning model arrives at a specific prediction in response to a particular input. Currently, the performance of such machine learning models is determined by comparing the predictions output by the model with expected outputs. However, the usefulness of this approach is limited. This approach can be used to determine whether the predictions output by the model are correct but provides no incite in to how the model arrived at that prediction, because the underlying knowledge encoded by the model is not evident in the output of the model.

The techniques described herein provide a deeper understanding of the behavior of machine learning models that can be used to improve the development and performance of such machine learning models. These techniques may be applied to transformer models and/or other models that utilize self-attention. Transformer models are deep learning models that utilize self-attention to differentially weight the significance of each part of the input data. Self-attention effectively allows the model to focus certain parts of the input data when making a prediction. Transformer models and other such models that use self-attention typically include multiple layers and the self-attention mechanism of the model may focus on different parts of the input data at different layers of the model. The techniques herein combine the self-attention information from each of the layers of the model to generate a computation graph that provides a higher-order representation of the behavior of the model across these layers. The computation graph is then analyzed by a graph attention model. The graph attention model is trained to analyze such computation graphs to combine information across the disparate layers of the model to output information that explains the decisions made by the model and to locate portions of the architecture of the model dedicated to performing specific tasks. A technical benefit of this approach is that the information output by the graph attention model provides an important insight into the behavior of the machine learning model that cannot be determined by merely comparing the output of the model to expected values. These and other technical benefits of the techniques disclosed herein will be evident from the discussion of the example implementations that follow.

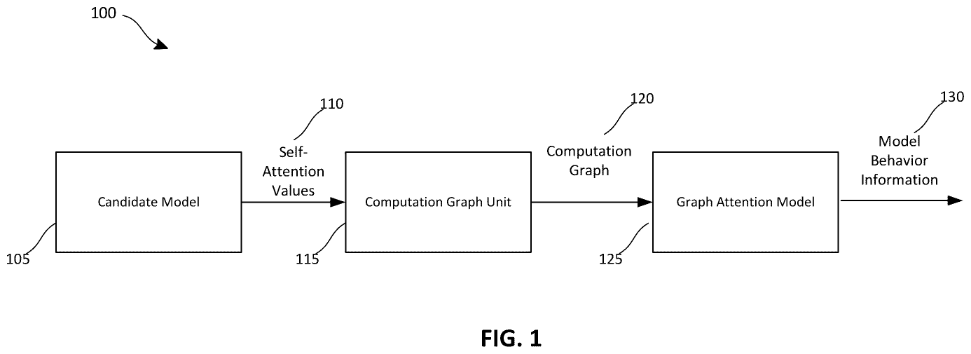

FIG. 1 is a diagram showing an example computing environment 100 in which the techniques provided herein for analyzing performance of a machine learning model may be implemented. The computing environment 100 includes a candidate model 105, a computation graph unit 115, and a graph attention model 125.

The candidate model 105 is a machine learning model that has been trained on a dataset to perform specific tasks on input data and to output predictions based on that input data. The performance of the candidate model 105 is evaluated using the techniques provided herein to determine whether the model is behaving as expected. These techniques provide an insight into how the candidate model 105 computes predictions at deep level including identifying which portions of the model architecture contribute most to the predictions output by the model.

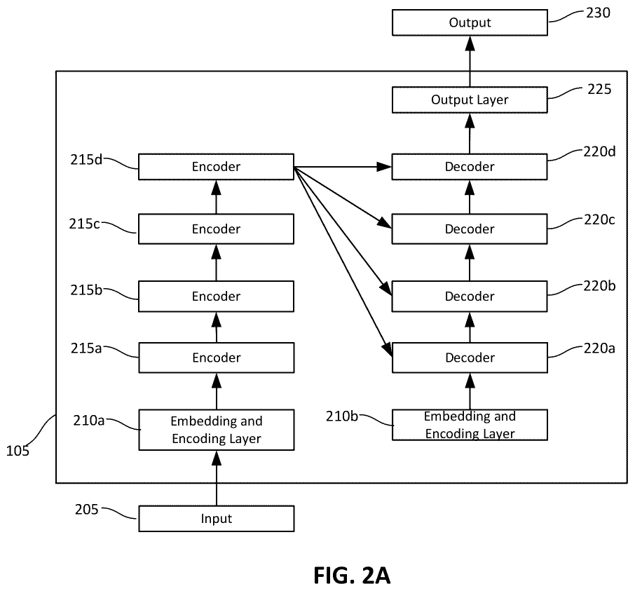

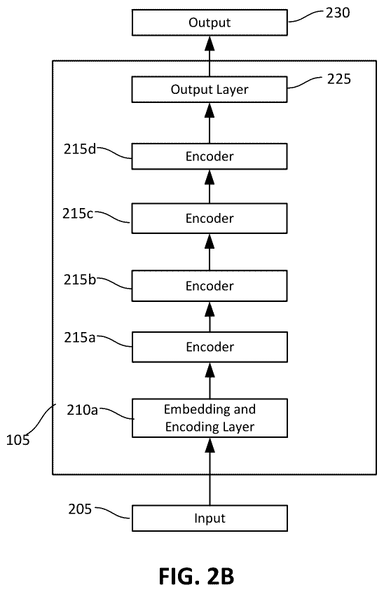

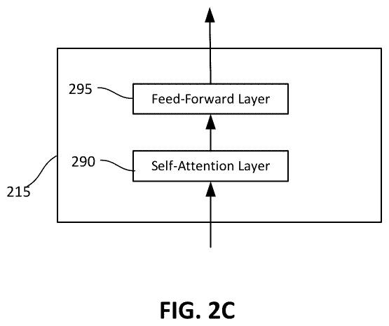

The candidate model 105 is a machine learning model that utilizes self-attention to analyze the input data across multiple layers of the model. The non-limiting examples described herein focus on transformer models, but these techniques may be extended to any type of machine learning model that utilizes self-attention across multiple layers of the model. The techniques described herein determine how the candidate model 105 generates a particular prediction by analyzing the self-attention information across the layers of the model. The architecture of the candidate model 105 may vary from implementation to implementation. Some non-limiting example architectures are provided in FIGS. 2A, 2B, and 2C. These implementations are described in detail in the example which follow.

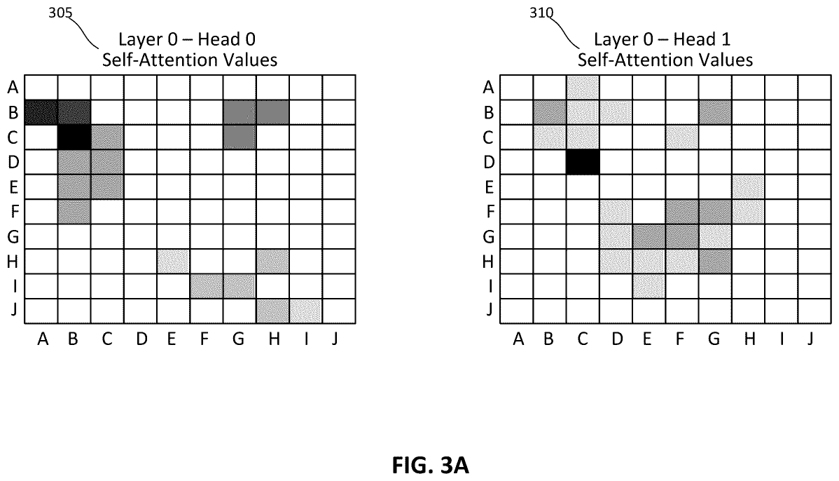

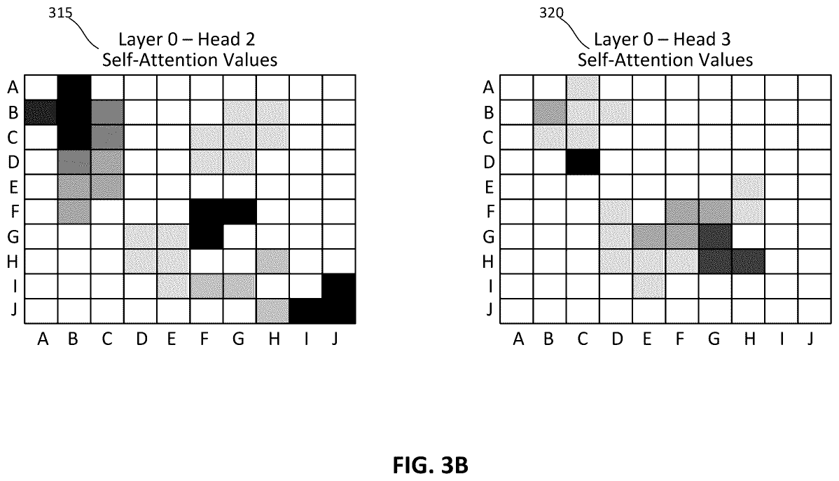

The computation graph unit 115 is configured to analyze self-attention values 110 associated with the candidate model 105. The candidate model 105 may include multiple self-attention layers that generate one or more attention matrices that comprise the self-attention values 110 analyzed by the computation graph unit 115. The self-attention values 110 includes information that indicates part of the input information on which the self-attention layers of the candidate model 105 focused while computing predictions. Each self-attention layer may process the information in multiple ways. Therefore, the self-attention information 110 may include multiple sets of attention data generated by each of the self-attention layers of the candidate model 105. These sets of data may be expressed as self-attention matrices. Examples of such self-attention matrices are shown in FIGS. 3A and 3B. The details of these self-attention matrices are described in detail in the examples which follow.

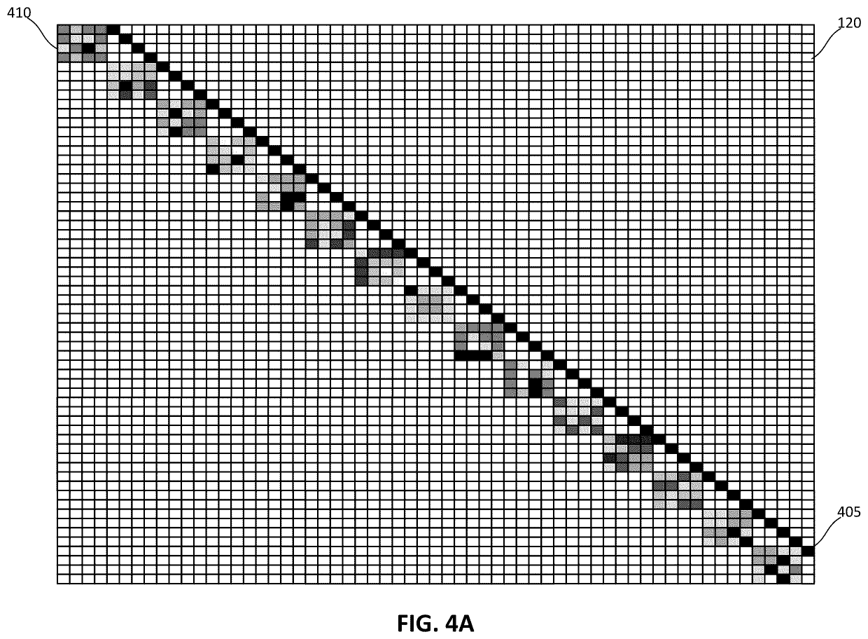

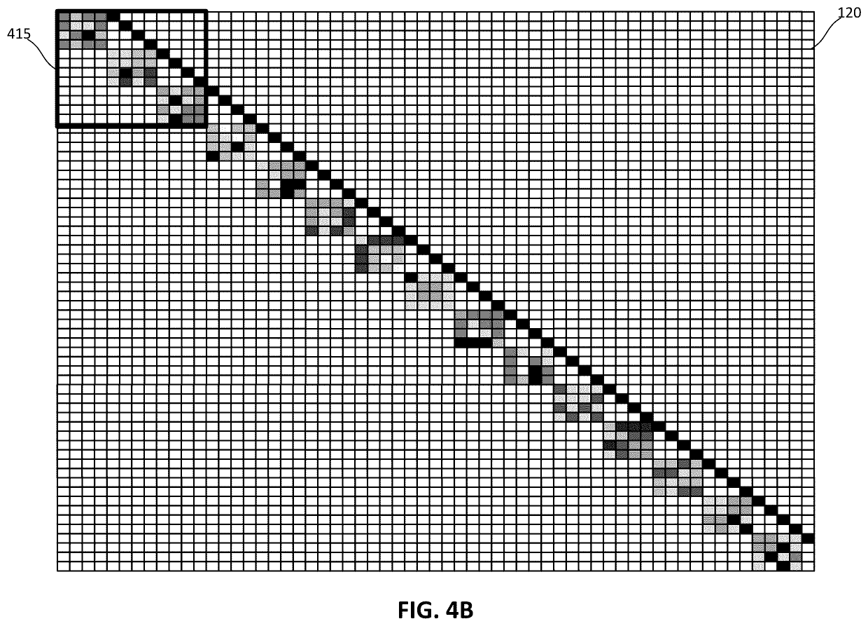

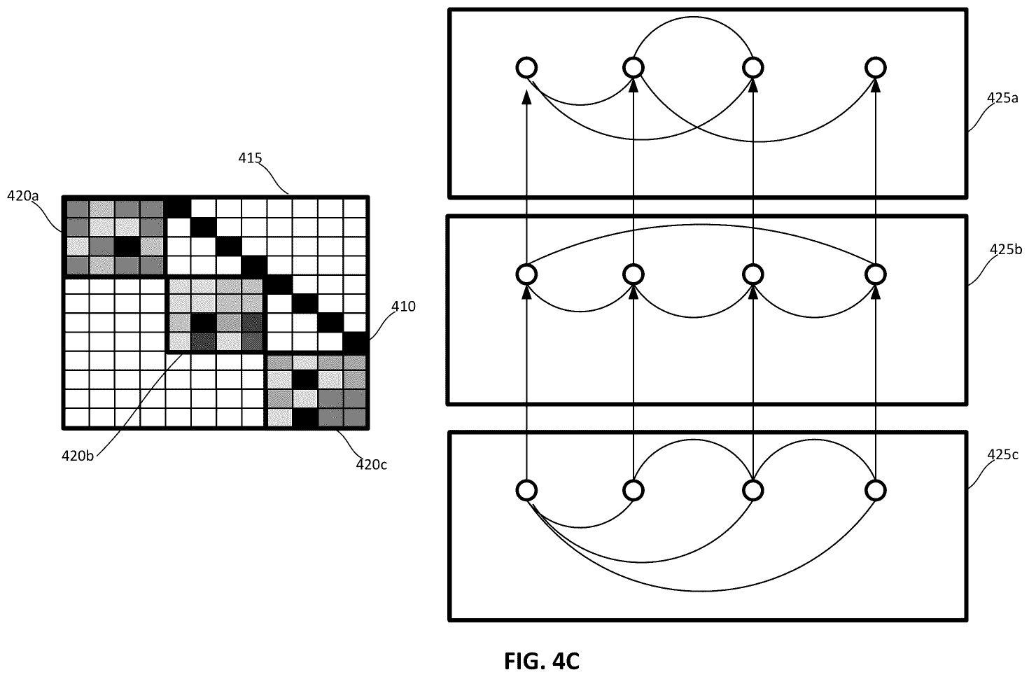

The computation graph unit 115 is configured to analyze the self-attention values 110 and to generate the computation graph 120 based on these self-attention values 110. The computation graph 120 combines the self-attention values 110 from each of the layers of the candidate model 105 to generate the computation graph 120 that provides a higher-order representation of the behavior of the candidate model 105. The self-attention values 110 may include self-attention matrices from each of the self-attention layers of the candidate model 105. The computation graph 120 may include a representation of these pair-wise similarity values as relative distances between nodes of the computation graph 120. These nodes can represent individual tokens or other parts of an input processed by the candidate model 105. An example of a computation graph 120 is shown in FIGS. 4A, 4B, and 4C. The examples which follow describe how the computation graph 120 may be generated by the computation graph unit 115 from the self-attention values 110.

The computation graph 120 is provided as an input to the graph attention model 125. The graph attention model 125 is configured to analyze the computation graph 120 and to output model behavior information 130. The graph attention model 125 combines information across the disparate attention layers of the candidate model 105 which are not connected in the original computations performed by the candidate model 105.

Consequently, the model behavior information 130 output by the graph attention model 125 provides insights into the decision-making process utilized by the candidate model 105 that would otherwise be opaque when examining the predictions output by the candidate model 105. The model behavior information 130 includes information that explains how the candidate model 105 computes the predictions output by the model, including layers of the architecture of the model are dedicated to performing specific tasks associated with generating the prediction.

Additional technical benefits provided by these techniques include reducing the computing, memory, and network resources associated with the development of machine learning models, such as the candidate model 105. The techniques provided herein can be used to analyze the performance of the model and to determine whether the candidate model 105 is working as expected by examining the reasons why the model makes certain predictions. This approach provides a significant insight into the behavior of the model that without requiring extensive testing of the model with test data and comparing the predictions made by the model base with the test data to expected results.

FIGS. 2A, 2B, and 2C show example implementations of a transformer model that may be used to implement the candidate model 105 shown in FIG. 1. FIG. 2A shows a first example architecture of a transformer model that may be used to implement the candidate model 105 that includes both encoder and decoder layers. FIG. 2B show a second example architecture of the transformer model that may be used to implement the candidate model 105 that omits the decoder layers. FIG. 2C shows an example of a self-attention module that may be utilized by the encoder layers of the example architectures shown in FIGS. 2A and 2B.

Referring to FIG. 2A, the candidate model 105 receives an input 205. The type of input 205 received depends upon the type of data that the candidate model 105 is trained to analyze. The input 205 may be textual content, image content, video content, and/or other types of content. Transformer models are commonly used in natural language processing (NLP) and computer vision applications but may be adapted for use in other applications.

The input 205 is analyzed by the embedding and encoding layer 210a. The embedding and encoding layer 210a converts the input 205 into embeddings. The embedding and encoding layer 210a may first break the input 205 up into part. For example, textual input may be broken up into word tokens, image inputs may be broken up into image patches, and/or other types of input may also be subdivided into parts to facilitate analysis by the candidate model 105. These parts may then be translated into embeddings. Embeddings are numerical vectors that represent the features of the parts of the input and are in a format that the candidate model 105 can analyze. The embeddings may also be associated with positional information that indicate where each part of the input was positioned in the input 205. The position information may include word order information for textual inputs, image patch information for image inputs, and/or other types of position information for other types of inputs. The embeddings and the positional information are provided as an input to the first of the encoder 215a.

The candidate model 105 typically includes multiple encoders layers that generate embeddings that indicate which parts of the input are relevant to each other and to perform additional processing on the embeddings. The encoder layers include a self-attention layer that makes the determination of relevance. In the example implementation shown in FIG. 2A, the candidate model 105 includes four encoder layers 215a, 215b, 215c, and 215d. Other implementations may include a different number of encoder layers. The encoder layers 215a, 215b, 215c, and 215d (collectively referred to as encoder layer 215) each have the same configuration, and the encoder layers 215 operate sequentially. The encodings output from the encoder layer 215a are provided as an input to the encoder layer 215b. The encodings output from the encoder layer 215b are provided as an input to the encoder layer 215c. Finally, the encodings output from the encoder layer 215c are provided as an input to the encoder layer 215d.

The candidate model 105 may also include decoder layers 220a, 220b, 220c, and 220d (collectively referred to as decoder layer 220). The candidate model 105 will typically include the same number of decoder layers as encoder layers. However, as shown in FIG. 2B, some implementations of the candidate model 105 may omit the decoder layers 220a, 220b, 220c, and 220d entirely. The embeddings output by the final encoder layer 220d are provided as an input to each of the decoder layers 220a, 220b, 220c, and 220d. The decoder layers analyze the embeddings and generate an output sequence. The decoder layers 220 include a self-attention layer that helps to determine relevance similar to the self-attention layers of the encoder layers 215. The output sequence output by the decoder layers 220 is provided to the output layer 225. The output layer 225 is configured to perform additional processing on the output of the decoder layers 220a, 220b, 220c, and 220d to generate the output 230 for the candidate model 105. The content of the output 230 depends on what the candidate model 105 has been trained to predict based on the input 205.

FIG. 2C shows an example implementation of an encoder layer 215. The encoder layer 215 includes a self-attention layer 290 and a feed-forward layer 295. The input to the encoder layer 215 is the encodings output by a preceding encoder layer 215, except for the first encoder layer 215a which receives the output of the embedding and encoding layer 210a as an input.

The self-attention layer 290 is configured to determine the relevance of the parts of the inputs received from the preceding encoder layer 215 or the embeddings information received from the embedding and encoding layer 210a. The self-attention layer 290 compares each of the tokens of textual input, patches of image input, or other parts of the input being analyzed depending upon the implementation of the candidate model 105 and determines a pair-wise similarity value (also referred to as a weight) for each pair of parts. The self-attention layer 290 identifies similarities between each the individual tokens, patches, or other parts of the input 205 being analyzed. These similarities are represented as pairwise similarity values where pairs of tokens, patches, or other parts of the input 205 are compared. The self-attention layer 290 associates a higher weight to pairs that determined to be more relevant to each other while a lower weight is assigned to pairs that are determined to be less relevant to each other. The weights assigned to different pairs may vary among the encoder layers 215 of the candidate model 105. FIGS. 3A and 3B, described in the examples which follow, include graphs of examples of self-attention matrices that may be generated by the self-attention layer 290. The self-attention layer 290 outputs weighted embedding information which is provided as an input to the feed-forward layer 295.

The feed-forward layer 295 implemented by a feed-forward neural network. The feed-forward layer 295 performs additional processing on the embeddings output by the self-attention layer 320. The feed-forward layer 295 may also be configured to normalize the embeddings before outputting the embeddings for processing by subsequent layers of the candidate model 105.

FIGS. 3A and 3B are graphs of example self-attention matrices that may be generated by the self-attention layer 290. The self-attention layer 290 may process the embeddings multiple times in parallel for each encoding layer 215a, 215b, 215c, and 215d of the candidate model 105. Each of these separate calculations of the attention model are referred to as attention heads. The attention outputs from the attention heads are then concatenated before outputting embedding information to the feed-forward layer 295.

The examples shown in FIGS. 3A and 3B include four sets of self-attention matrices 305, 310, 315, and 320 generated by four of the heads associated with encoder layer 215a of the candidate model 105. The encoder layer 215a may include additional heads that also generate self-attention matrices. Furthermore, each of the attention heads of the encoding layers 215b, 215c, and 215d also generate similar self-attention matrices. In the example shown in FIGS. 3A and 3B, the input is broken into ten parts, each of which have been labeled with a respective letter from A-J. Each of the parts of the input may represent a word of a textual input, a patch of an image input, or other portion an input to the candidate model 105. The self-attention layer 290 determines an attention weight for each pairwise comparison of the parts. In the examples shown in FIGS. 3A and 3B, the rectangles of the graph of the self-attention values 305, 310, 315, and 320 are shaded according to the attention weight assigned to each pair by the self-attention layer 290. The darker the shading of a particular rectangle, the higher the attention weight assigned by the self-attention layer 290. The weight represents how relevant the self-attention layer 290 of the encoder layer 215 found the pair of parts of the input. While the graphs of the self-attention matrices shown in FIGS. 3A and 3B represent the attention weights associated with the pairs using shading, the underlying pairs are associated with a numerical weight value, and the graphs shown in FIGS. 3A and 3B are merely examples of one way that this data may be visualized. The self-attention matrices associated with each of the heads may be combined to create a final version of the self-attention matrix for the self-attention layer.

FIGS. 4A, 4B, and 4C are diagrams of an example computation graph generated by the computation graph unit from the self-attention values shown in FIGS. 3A and 3B. The computation graph 120 is a matrix that represents the computation of the candidate model 105. The computation graph unit 115 generates the computation graph 120 (also referred to herein as a computational matrix), which represents all the computations that the model performed to generate predictions, using the following process. This process assumes that the candidate model 105 is a transformer model, but the process can be adapted to other types of models that include self-attention layers that generate attention matrices. Furthermore, where the self-attention layer includes multiple attention heads, the attention matrix utilized by the computation graph unit 115 may be the final version of the self-attention matrix created by merging the self-attention matrices of each of the heads for the respective self-attention layer.

For a given transformer model with k sequential encoder layers and a sequence of input values (t_0, . . . ,t_n), let A_i(x) be the attention matrix from the encoder layer L_i when the model is applied to x. For each given input x, the computation graph unit 115 constructs the computation matrix as a block matrix whose diagonal blocks 410 are A_i(x) and whose off-diagonal blocks 405 are identity matrices that represent forward connections between layers. The computation matrix is itself an adjacency matrix of a graph, where each node is a token at a particular layer. The adjacency matrix represents the graph as a matrix of Boolean values, and each Boolean value of the matrix indicate whether there is a direct path between two nodes of the graph. Accordingly, each value in the computation matrix represents either: (1) the token's attention weight at that layer; or (2) an identity weight, representing a connection between (layer_number, token_number) and (layer_number+1, token_number).

FIG. 4B shows an example in which a section 415 of the computation graph 120 has been highlighted. FIG. 4C shows the section 415 in greater detail. Sections 420a, 420b, and 420c of the graph represent three layers of the transformer model. The sections 420a, 420b, and 420c of the computation graph 120 represent are a cumulative representation of the self-attention values for all the heads associated with the respective layer represented by to respective section 420a, 420b, and 420c. In the example implementation shown in FIG. 4A-4C, assume that each of the layers are associated with four nodes and each layer is represented by a 4×4 grid, such as the sections 420a, 420b, and 420c of the computational graph shown in FIG. 4C. The graphs 425a, 425b, and 425c correspond to sections 420a, 420b, and 420c of the computational graph 120 respectively. The graphs 425a, 425b, and 425c show the links between the nodes associated with each layer and also show the forward connections that link the nodes between the layers.

Viewing the computation matrix as a computation graph 120, different featurizations of this graph are useful. For example, a sparse version of this graph that keeps only the top k % of edge (matrix values) and yields a more compact representation of only the largest connections. This approach may be used to filter out more tenuous connections that that may have more negligible impact on the predictions made by the candidate model 105. Other modifications may also be made to the modify the representation of the behavior of the candidate model 105 to highlight certain characteristics of the behavior of the candidate model 105.

The graph attention model 125 can be used to analyze the computation graph 120 generated by the computation graph unit 115 to generate model behavior information 130 for the candidate model 105. In some implementations, the graph attention model 125 is a transformer-based model F with graph tokenization prior to computing self-attention between the input nodes. The nodes in the computation graph 120 directly correspond to (layer_number, part_number) pairs for the candidate model 105. As discussed in the preceding examples, the input to the model is broken up into parts for analysis. These parts may represent word tokens, image patches, or other parts of the inputs.

The graph attention model 125 can be used to identify cross-layer dependencies that contributed to the predictions output by the candidate model 105. The attention matrices of the graph attention model 125 identify critical information flows through the network of the candidate model 105, while still having the ability to retrain the graph attention model 125 for different tasks. The graph attention model 125 can also yield new embeddings which are task specific.

Another technical benefit of the computation graph 120 is that this higher-order representation of the behavior of the candidate model 105 may also be used as a training data set for a classification model. The computation graph 120 may be provided to the classifier analyze tasks other than those for which the candidate model 105 was trained. The behavior of the classification model can be monitored, and user feedback provided to fine-tune the behavior of the classification model. A technical benefit of this approach is that the behavior of the classification model can be fine-tuned without needing to retrain the larger candidate model 105.

Another technical benefit of the modularization of the architecture allows for new task-specific explainable graph transformations to be created without the more expensive training of the original model. This approach a new take on the traditional “fine tuning” of a model, while still creating explanations in terms of raw input. Furthermore, another technical benefit of this approach is that the new representation can be used for other regression or classification problems or generic indexing functionality beyond the examples described herein.

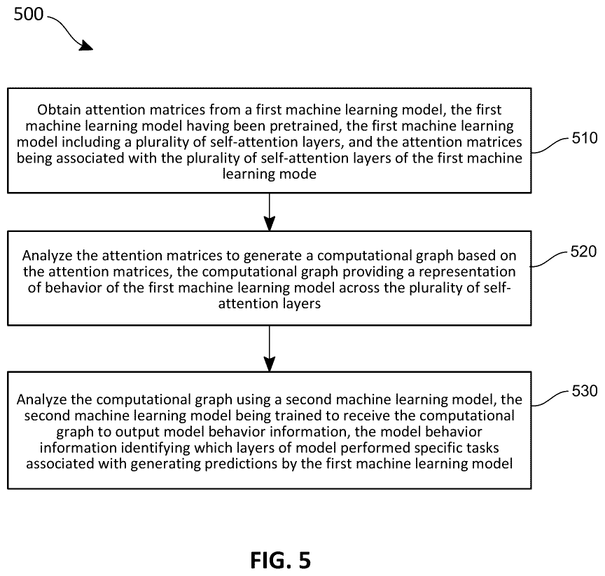

FIG. 5 is an example flow chart of an example process 500 for analyzing performance of a machine learning model. The process 500 includes an operation 510 of obtaining attention matrices from a first machine learning model. The first machine learning model is a pretrained, such as the candidate model 105. The first machine learning model includes a plurality of self-attention layers, and the attention matrices are associated with the plurality of self-attention layers of the first machine learning model.

The process 500 includes an operation 520 of analyzing the attention matrices to generate a computation graph 120 based on the attention matrices. The computation graph 120 provides a representation of behavior of the first machine learning model across the plurality of self-attention layers. The computation graph unit 115 is configured to receive as an input the self-attention values 110, including the attention matrices from each of the self-attention layers of the candidate model 105, and to output the computation graph 120.

The process 500 includes an operation 530 of analyzing the computation graph using a second machine learning model, such as the graph attention model 125. The second machine learning model has been trained to receive the computation graph to output model behavior information. The model behavior information identifying which layers of model performed specific tasks associated with generating predictions by the first machine learning model.

The detailed examples of systems, devices, and techniques described in connection with FIGS. 1-5 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-5 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

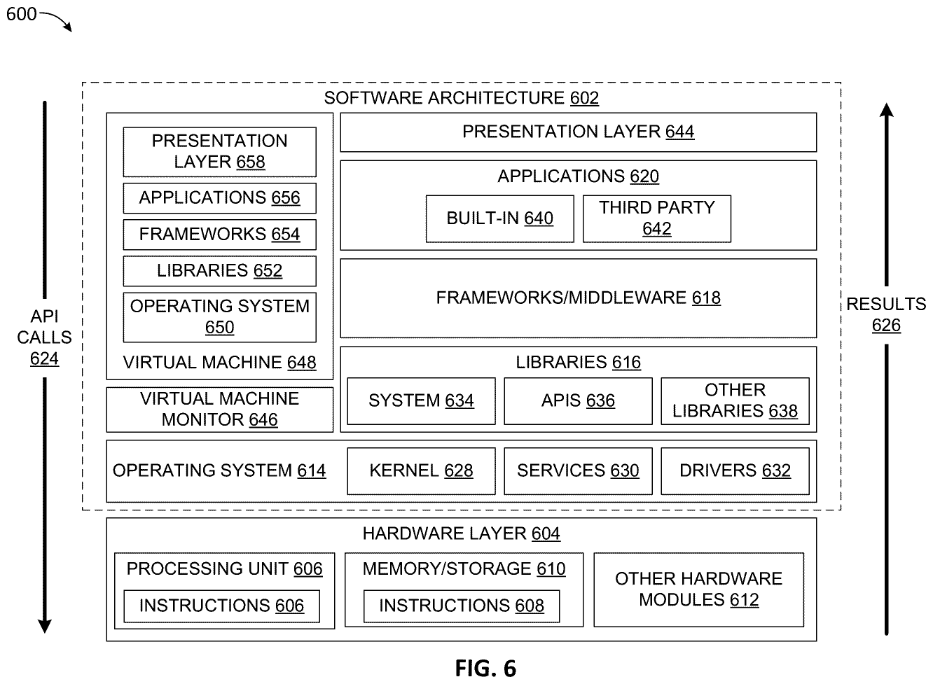

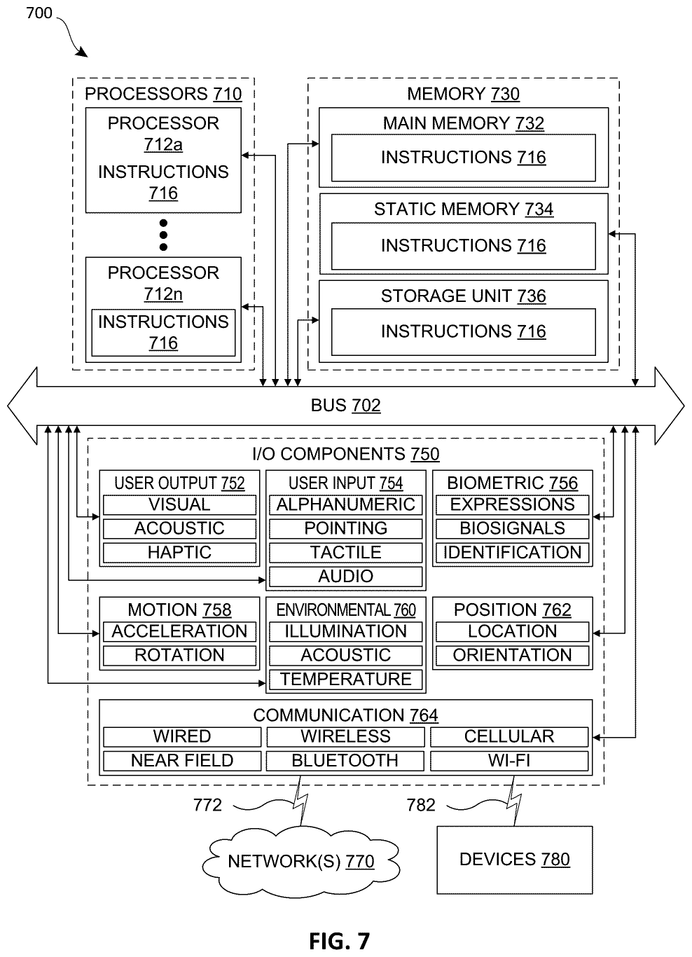

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable storage medium storing executable instructions that, when executed, cause the processor to perform operations comprising:
obtaining attention matrices from a first machine learning model, the first machine learning model having been pretrained, the first machine learning model including a plurality of self-attention layers, and the attention matrices being associated with the plurality of self-attention layers of the first machine learning model;
analyzing the attention matrices to generate a computation graph based on the attention matrices, the computation graph providing a representation of behavior of the first machine learning model across the plurality of self-attention layers; and
analyzing the computation graph using a second machine learning model, the second machine learning model being trained to receive the computation graph to output model behavior information, the model behavior information identifying which layers of model performed specific tasks associated with generating predictions by the first machine learning model.

2. The data processing system of claim 1, wherein the first machine learning model is a transformer model, and wherein the self-attention layers are one or more encoding layers or one or more encoding layers and one or more decoding layers.

3. The data processing system of claim 1, wherein the attention matrices include pair-wise similarity values for each token of a plurality of tokens of an input to the first machine learning model, and wherein the computation graph includes a representation of the pair-wise similarity values as relative distances between nodes representing the plurality of tokens.

4. The data processing system of claim 3, wherein analyzing the attention matrices to generate the computation graph further comprises:
generating a block matrix having diagonal blocks comprising attention weights based on the attention matrices from the plurality of self-attention layers of the first machine learning model and off-diagonal blocks comprising identity matrices representing forward connections between self-attention layers.

5. The data processing system of claim 4, wherein a respective forward connection represents a connection between a respective token at a respective self-attention layer and the respective token at a next self-attention layer of the first machine learning model.

6. The data processing system of claim 4, wherein the block matrix is generated by processing the attention matrices associated with each of the self-attention layers sequentially such that representations of sequential self-attention layers are adjacent on the computation graph.

7. The data processing system of claim 4, wherein the machine-readable storage medium includes instructions configured to cause the processor to perform operations of:
filtering the attention weights to exclude weights fall outside a predetermined percentage to generate a sparse version of the computation graph.

8. A method implemented in a data processing system analyzing performance of a machine learning model, the method comprising:
obtaining attention matrices from a first machine learning model, the first machine learning model having been pretrained, the first machine learning model including a plurality of self-attention layers, and the attention matrices being associated with the plurality of self-attention layers of the first machine learning model;
analyzing the attention matrices to generate a computation graph based on the attention matrices, the computation graph providing a representation of behavior of the first machine learning model across the plurality of self-attention layers; and
analyzing the computation graph using a second machine learning model, the second machine learning model being trained to receive the computation graph to output model behavior information, the model behavior information identifying which layers of model performed specific tasks associated with generating predictions by the first machine learning model.

9. The method of claim 8, wherein the first machine learning model is a transformer model, and wherein the self-attention layers are one or more encoding layers or one or more encoding layers and one or more decoding layers.

10. The method of claim 8, wherein the attention matrices include pair-wise similarity values for each token of a plurality of tokens of an input to the first machine learning model, and wherein the computation graph includes a representation of the pair-wise similarity values as relative distances between nodes representing the plurality of tokens.

11. The method of claim 10, wherein analyzing the attention matrices to generate the computation graph further comprises:
generating a block matrix having diagonal blocks comprising attention weights based on the attention matrices from the plurality of self-attention layers of the first machine learning model and off-diagonal blocks comprising identity matrices representing forward connections between self-attention layers.

12. The method of claim 11, wherein a respective forward connection represents a connection between a respective token at a respective self-attention layer and the respective token at a next self-attention layer of the first machine learning model.

13. The method of claim 11, wherein the block matrix is generated by processing the attention matrices associated with each of the self-attention layers sequentially such that representations of sequential self-attention layers are adjacent on the computation graph.

14. The method of claim 11, further comprising:
filtering the attention weights to exclude weights fall outside a predetermined percentage to generate a sparse version of the computation graph.

15. A machine-readable medium on which are stored instructions that, when executed, cause a processor of a programmable device to perform operations of:
obtaining attention matrices from a first machine learning model, the first machine learning model having been pretrained, the first machine learning model including a plurality of self-attention layers, and the attention matrices being associated with the plurality of self-attention layers of the first machine learning model;
analyzing the attention matrices to generate a computation graph based on the attention matrices, the computation graph providing a representation of behavior of the first machine learning model across the plurality of self-attention layers; and
analyzing the computation graph using a second machine learning model, the second machine learning model being trained to receive the computation graph to output model behavior information, the model behavior information identifying which layers of model performed specific tasks associated with generating predictions by the first machine learning model.

16. The machine-readable medium of claim 15, wherein the first machine learning model is a transformer model, and wherein the self-attention layers are one or more encoding layers or one or more encoding layers and one or more decoding layers.

17. The machine-readable medium of claim 15, wherein the attention matrices include pair-wise similarity values for each token of a plurality of tokens of an input to the first machine learning model, and wherein the computation graph includes a representation of the pair-wise similarity values as relative distances between nodes representing the plurality of tokens.

18. The machine-readable medium of claim 17, wherein analyzing the attention matrices to generate the computation graph further comprises:
generating a block matrix having diagonal blocks comprising attention weights based on the attention matrices from the plurality of self-attention layers of the first machine learning model and off-diagonal blocks comprising identity matrices representing forward connections between self-attention layers.

19. The machine-readable medium of claim 18, wherein a respective forward connection represents a connection between a respective token at a respective self-attention layer and the respective token at a next self-attention layer of the first machine learning model.

20. The machine-readable medium of claim 18, wherein the block matrix is generated by processing the attention matrices associated with each of the self-attention layers sequentially such that representations of sequential self-attention layers are adjacent on the computation graph.
